(19) United States
(12) Patent Application Publication
(10) Pub. No.: US 2009/0104479 A1
(43) Pub. Date: Apr. 23, 2009

(54) FUEL CELL WITH AN ION WICK

(75) Inventors: Paul A. Kohl, Atlanta, GA (US); William E. Mustain, Manchester, CT (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: GEORGIA TECH RESEARCH CORPORATION, Atlanta, GA (US)

(21) Appl. No.: 12/256,118

(22) Filed: Oct. 22, 2008

Related U.S. Application Data
(60) Provisional application No. 60/981,578, filed on Oct. 22, 2007.

(51) Int. Cl. H01M 8/04; H01M 8/10

(52) U.S. Cl. 429/13; 429/30

(57) ABSTRACT

The present disclosure relates to a proton exchange membrane fuel cell comprising an ionically conductive liquid fuel solution, an anode configured to remain in contact with the fuel regardless of the orientation of the fuel cell, and a wicking material disposed within the fuel cell such that a part of the wick is in contact with the liquid fuel solution in any orientation of the fuel cell and such that a portion of the wicking material is in contact with the solid proton exchange membrane in any orientation of the fuel cell. The wicking material provides an ion pathway for transporting ions generated around the anode to the proton exchange membrane.

### RELATED APPLICATIONS

This application claims the benefit under 35 U.S.C. §119(e) to U.S. Provisional Patent Application No. 60/981,578, titled “FLOATING ANODE ION WICKING DIRECT METHANOL FUEL CELL,” filed Oct. 22, 2007, which is incorporated by reference in its entirety.

### FEDERALLY SPONSORED RESEARCH OR DEVELOPMENT

This invention was made with U.S. Government support under contract no.: N66604-06-C-2330 awarded by the U.S. Department of Defense, Department of the Navy. The U.S. Government has certain rights in this invention.

### BRIEF DESCRIPTION OF THE DRAWINGS

Non-limiting and non-exhaustive embodiments of the disclosure are described, including various embodiments of the disclosure with reference to the figures, in which:

FIG. 1 is a cross-sectional view of a fuel cell.

FIG. 2A shows a direct methanol fuel cell incorporating a floating anode and an ion wick in a “right-side up” orientation.

FIG. 2B shows a direct methanol fuel cell incorporating a floating anode and an ion wick in an “up-side down” orientation.

FIG. 3 shows a direct methanol fuel cell where the fuel reservoir is the anode.

FIG. 4A shows a direct methanol fuel cell where the fuel reservoir is the anode in a “right-side up” orientation.

FIG. 4B shows a direct methanol fuel cell where the fuel reservoir is the anode in an “up-side down” orientation.

FIG. 5 shows the results of a polarization experiment for a direct methanol fuel cell comprising a floating anode and an ion wicking material in two different cell orientations.

FIG. 6 shows the results of a chronoamerometric experiment for a direct methanol fuel cell comprising a floating anode and an ion wicking structure in two different cell orientations.

### DETAILED DESCRIPTION OF THE EMBODIMENTS

The embodiments of the disclosure will be best understood by reference to the drawings, wherein like parts are designated by like numerals throughout. It will be readily understood that the components of the embodiments as generally described and illustrated in the figures herein could be arranged and designed in a wide variety of different configurations. Thus, the following more detailed description of various embodiments, as represented in the figures, is not intended to limit the claim scope, but is merely representative of various embodiments. While the various aspects of the embodiments are presented in drawings, the drawings are not necessarily drawn to scale unless specifically indicated.

A fuel cell is an electrochemical energy conversion device that produces electricity from a fuel. The present disclosure relates generally to proton-exchange fuel cells, including direct methanol fuel cells (DMFC), direct ethanol fuel cells, formic acid fuel cells, and the like. As the names imply, one of the two redox processes in these fuel cells is fueled by methanol, ethanol, and formic acid, respectively. Other fuels may also be used in proton-exchange fuel cells, including but are not limited to butanol, glycols, diglycols such as ethylene diglycol, organic acids such as formic acids, acetic acids, and aldehydes such as formaldehyde. The specific embodiments discussed below relate generally to DMFCs; however, the teachings are more generally applicable to proton-exchange fuel cells utilizing any liquid fuel, including, but not limited to, the fuels listed above.

In a DMFC, methanol fuel is fed directly to the fuel cell. The anode and cathode reactions in a DMFC can be expressed as follows:

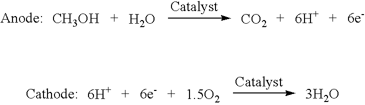

DMFCs are attractive power sources for a variety of low-power applications with electrical current requirements ranging between a few microamps to about 30 milliamps and power requirements between 1 μW and 1000 μW. Larger power requirements may be satisfied by using a plurality of DMFCs in combination. Applications for DMFCs may include but are not limited to electronic battery replacements, wireless sensors (including temperature sensors, pressure sensors, active RFID tags, and the like), meter readers (including water and gas meter readers), fire alarms, and a wide variety of consumer electronic devices (including cellular telephones, mobile computers, and the like).

In the applications listed above, maintaining a high volumetric energy density is a key design parameter that effectively precludes the use of traditional active fuel delivery systems and other components, such as a fuel pump, fan, humidification, and reactant and product controls. In addition to consuming space, these components consume power as well as add cost and complexity to the fuel cell.

Such applications further require the ability to operate consistently in any orientation and to maximize the life span over which the fuel cell provides power to the device. In portable devices, the device may be moved and rotated in any orientation. Fuel may be wasted or the operation of the fuel cell may cease if the orientation of the cell causes the anode to lose contact with the fuel. A wick has been used to reach the extremities of a fuel reservoir; however, a fuel wick may result in inconsistent concentration gradients and unpredictable performance for long-term operation because fibrous or porous wicking materials transport liquids selectively based on the surface tension of the liquid. This is a problem for DMFCs because methanol, like other alcohols, has a lower surface tension than water. The difference in surface tension results in an inconsistent concentration gradient along the wick. As the length of the wick increases, the ratio of methanol to water in the wick will increase. This phenomenon limits the practical length of a wick and may reduce the efficiency of the fuel cell. As used herein “wicking” means transporting an atom or molecule by capillary forces. A wicking material is a material that is capable of transporting an atom or molecule by capillary forces.

In addition to the above-described design challenges, the efficiency of DMFCs is lowered by methanol crossover. Crossover refers to methanol reaching the cathode and oxidizing. The electrons resulting from the oxidation reaction at the cathode do not follow the current path between the electrodes, and thus reduce the efficiency of the cell. In addition to lowering the efficiency of the cell in operation, methanol crossover wastes fuel even when the cell is not in use.

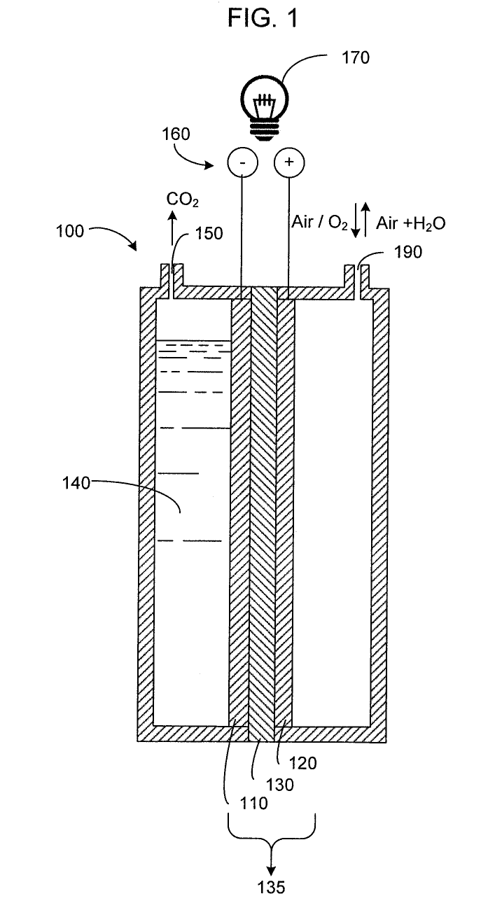

With reference to the accompanying figures, particular embodiments will now be described in greater detail. As shown by FIG. 1, a typical fuel cell 100 may include an anode 110 and a cathode 120 separated by a proton-exchange membrane (PEM) 130. The anode 110 may be disposed on one side of the PEM 130, and the cathode 120 may be disposed on the opposite side of the PEM 130. The assembly comprising the cathode 120, the PEM 130, the and anode 110 may be referred to as a membrane electrode assembly (MEA) 135. The PEM 130 may comprise any proton conducting electrolyte, including the perflourinated sulfonic acid polymer commercially available under the registered trademark Nafion from DuPont Chemical Co. Other commercially available proton conducting electrolytes include, but are not limited to: Hyflon from Dow Chemical Company, Flemion from Asahi Glass company, Aciplex-S from Asahi Glass Company, Neosepta-F from Tokuyama Corporation, Gore Select from W. L. Gore & Associates, polystyrene sulfonic acid membranes, poly(vinyl alcohol)-poly(2-acrylamido-2-methyl-1-propanesulfonic acid), poly ether ether ketone, sulfonate poly ether ether ketone, sulfonated poly phenylene oxide, polybenzimidazole, polyimides, P2O5-ZrO2-SiO2 glass, and P2O5-TiO2-SiO2 glass.

In operation, a fuel 140, such as liquid methanol, is oxidized at the anode 110, in the presence of a catalyst (e.g. Pt—Ru) and water (H₂O), to produce electrons (e⁻), hydrogen cations (H⁺), and carbon dioxide (CO₂). The fuel cell 100 may include a vent 150 to allow the escape of reaction gases, such as CO₂ gas. The electrons flow from the anode 110 to the cathode 120 through an external circuit 160 electrically connected between the anode 110 and the cathode 120. The external circuit 160 delivers electrical energy to an attached electrical device or storage device 170. Hydrogen cations (H⁺) pass through the PEM 130 and combine with oxygen (O₂), in the presence of a catalyst, to form water at the cathode 120. The vent 190 may allow air from the environment to enter the cathode chamber and provide the oxygen required for the reaction at the cathode. The vent 190 may also allow air and water to exit the cathode chamber.

In order to function with maximum efficiency, the PEM 130 may require a water balance between the cathode and the anode. As shown by the reactions that occur at the anode and cathode, water will migrate from the anode chamber to the cathode chamber as the reaction progresses. Water balance in the cell may be maintained by a variety of methods. For example, the cell may rely on passive water circulation as disclosed in U.S. Pat. Nos. 7,407,721, 7,201,992, and 6,989,206. In other embodiments, water may be wicked from the cathode to an anode vapor inlet as disclosed in U.S. Pat. No. 7,435,502, and Shanhai Ge, Xuguang Li, I.-Ming Hsing, Internally Humidified Polymer Electrolyte Fuel Cells Using Water Absorbing Sponge, 50 (9) ELECTROCHIMICA ACTA 1909 (2005). In still other embodiments, water may be wicked directly from the cathode into the PEM as disclosed in Masahiro Watanabe, Yasutaka Satoh, and Chiyoka Shimura, Management of the Water Content in Polymer Electrolyte Membranes with Porous Fiber Wicks, J. ELECTROCHEM. SOC. 140, 3190 (1993).

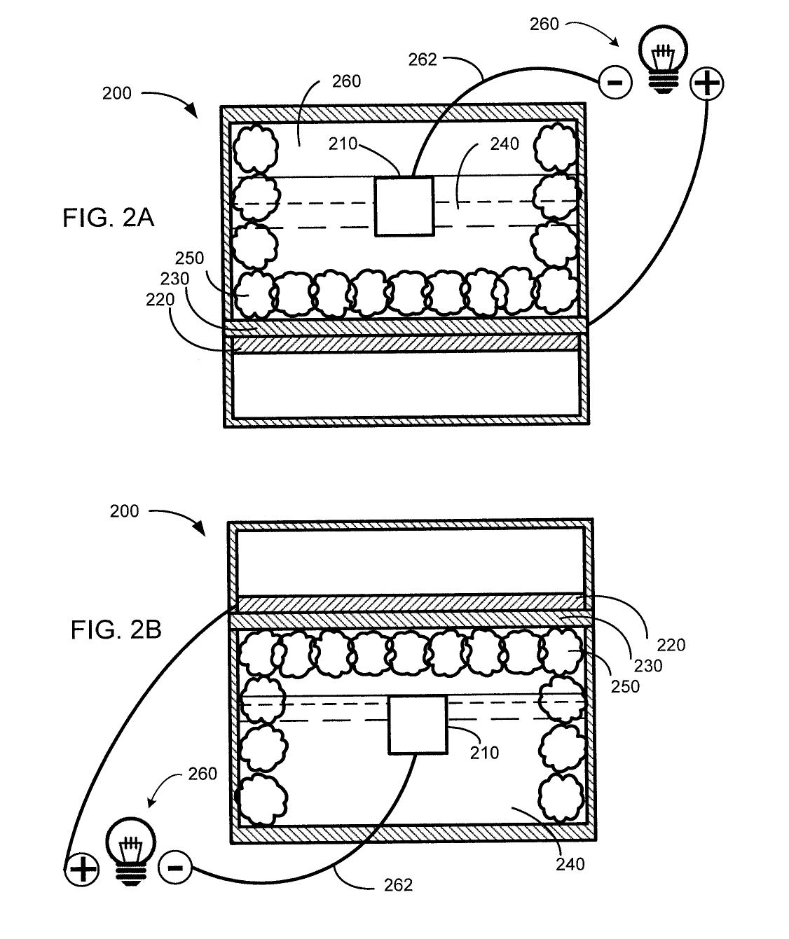

Referring to FIG. 2A, an alternative operating method for a passive fuel cell 200 is shown. Fuel cell 200 utilizes a fuel 240 that is ionically conductive. A small amount of an earth metal salt, such as potassium sulfate or sodium bisulfate can be added to the fuel to increase the ionic conductivity of the solution. A molar ratio of 0.001 M per liter to 0.1 M per liter earth metal salt may be acceptable. The fuel cell 200 further utilizes a wicking material 250 that is soaked in the fuel 240 and placed in contact with the solid proton exchange membrane 230 and the fuel 240.

The anode 210 is disposed in the liquid fuel, such that the anode 210 remains in contact with the fuel 240 regardless of the orientation of the fuel cell 200. In an embodiment shown in FIG. 2, the anode 210 may “float” in the fuel reservoir 260. As used herein, the term float means that the anode 210 is not rigidly attached to the structure of the fuel cell 200, but rather the anode 210 moves within the fuel reservoir 260 with the fuel. In this way, the anode 210 remains in contact with the fuel 240 regardless of the orientation of the fuel cell 200. The anode 210 may be connected to an external circuit 260 by a wire 262.

The electrons produced as a result of the oxidation of the fuel 240 are conducted by the anode 210 to the external circuit 260. Hydrogen cations (H⁺) generated by the oxidation are conducted through the ionically conductive fuel 240 to the PEM 230. The hydrogen cations pass through the PEM 230 and are consumed in the redox half reaction that occurs at the cathode 220.

Wicking material 250 provides an ion pathway between the anode 210 and the PEM 230 when the fuel cell is in an “up-side down” orientation. As illustrated in FIG. 2A, the fuel cell 200 may be described as being oriented “right-side up” when the fuel 240 is in direct contact with the PEM 230. In this orientation, the hydrogen cations may move from the anode 210 to the PEM 230 through the ionically conductive fuel 240 without the assistance of wicking material 250. As illustrated in FIG. 2B, the fuel cell 200 may be described as being oriented “up-side down” when the fuel 240 is not in direct contact with the PEM. Accordingly, in this orientation, wicking material 250 is required to transport ions produced at the cathode 210 to the PEM 230. As will be appreciated, the fuel cell 200 may also be oriented in any way between the “up-side down” and the “right-side up” orientations. In the various orientations between “up-side down” and “right-side up,” contact is maintained between the anode 210 and the ionically conductive fuel 240 because the anode 210 is not rigidly attached to the structure of the fuel reservoir 260. As such, the anode 210 may move within the fuel reservoir 260 under the influence of the same forces that affect the position of the ionically conductive fuel 240. Contact is also maintained between the fuel 240 and the PEM 230—either directly or by way of the wicking material 250—in the various orientations between “up-side down” and “right-side up”.

Suitable wicking materials comprise: cotton, linen, polyester, polyethylene, fiberglass, carbon cloth, hydrogels, polyamide, polypropylene, polyacrylonitile, poly vinyl acetate, poly vinyl alcohol, poly ethers, or mixtures of any of the foregoing. These materials may be woven or non-woven, bundled fibers, matted fibers, or foam. Wicking materials may also include cellulose foam, hydroxy-methyl-cellulose, and hydrogel woven fibers.

As described above, it is desirable to maximize fuel storage capacity and to utilize all fuel stored with a DMFC. Accordingly, it is desirable to minimize the space occupied by the wick, and to configure the wick to reach to all extremities of the fuel reservoir. In an embodiment, a wicking material 250 extends from the PEM 230 to the extremities of the fuel reservoir. By extending the wicking material to the extremities of the fuel reservoir 260 and by selecting a suitable wicking material, nearly all of the fuel 240 may be used. The wicking material 250 may be secured within the fuel reservoir using mechanical fasteners or an adhesive.

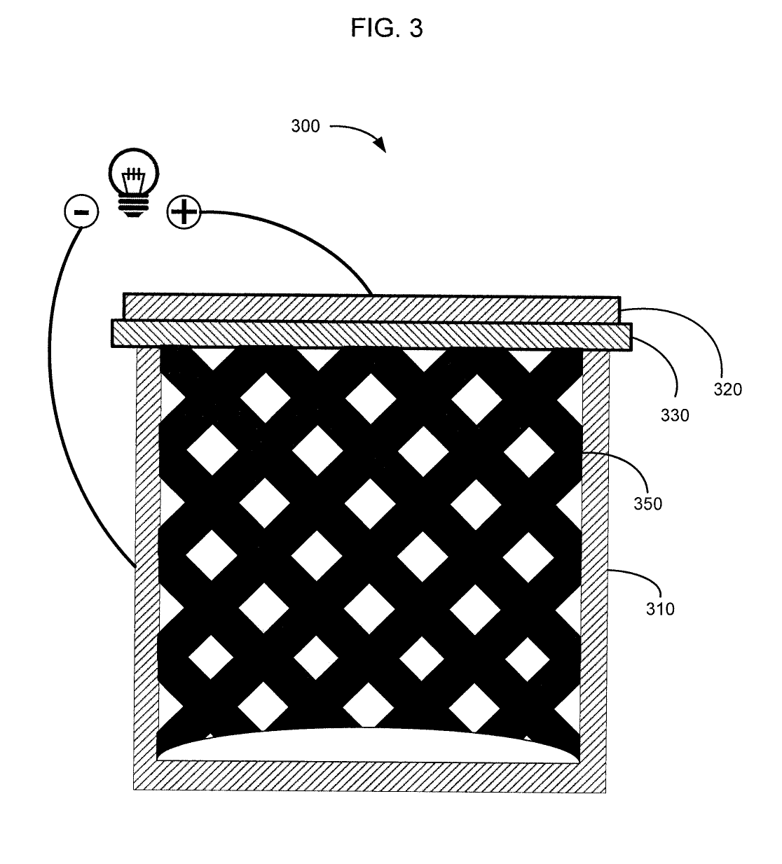

In another embodiment illustrated in FIG. 3, an anode 310 of a fuel cell 300 comprises the fuel reservoir, and accordingly, the fuel is always in contact with the anode 310 regardless of the orientation of the fuel cell 300. The wicking material 350 may be disposed around the fuel reservoir 310, such that the wicking material 350 is also in contact with the fuel regardless of the orientation of the cell. The wicking material 350 may be in the form of a lattice, as shown, or in a wide variety of other configurations. Similarly, the shape of the fuel reservoir 310 may be in any shape. As illustrated in FIG. 3, the fuel reservoir may be cylindrical. In another embodiment, the fuel reservoir 310 is approximately spherical, and the wicking material lines the interior of the spherical fuel reservoir.

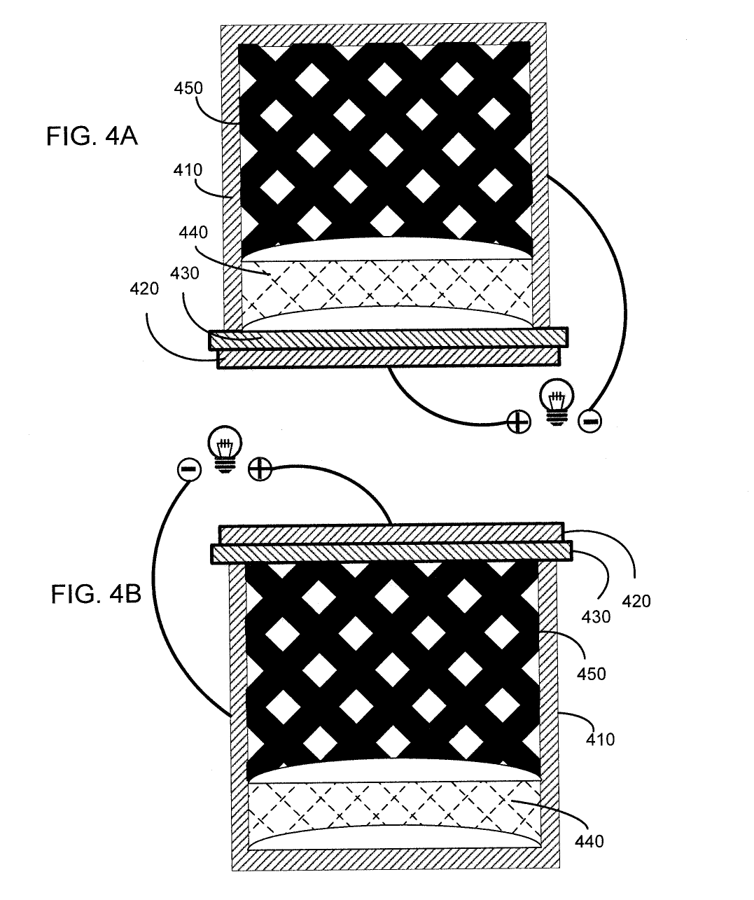

In the “right-side-up” orientation shown in FIG. 4A, the fuel 440 is in direct contact with the anode 410 and the PEM 430, thus allowing hydrogen cations produced at the anode to migrate through the ionically conductive fuel 440 to the PEM 430 without relying on wicking material 450. In the “up-side down” orientation shown in FIG. 4B, the wicking material 450 provides an ion pathway for hydrogen cations produced at the anode to migrate to the PEM 430.

There are several distinct advantages to the configuration shown in FIGS. 2A, 2B, 3 and 4A and 4B. First, by providing an ion pathway instead of a fuel delivery pathway using a wick, the rate of the reaction in the fuel cell may be increased. The increased reaction rate is in part attributable to the efficiency of conducting ions through the wick rather than conducting reactants (e.g. water and methanol) through the wick. A wick used to transport fuel and water is limited by the wicking ability of the wicking material and by the length of the wick. A fuel cell incorporating an ion wick may allow the fuel cell to operate at a higher current in comparison to a fuel cell that uses a wick to transfer fuel to an anode.

Second, the rate of reaction may be increased because a larger surface area of the anode is in contact with the fuel. Oxidation of the fuel will occur only where the fuel is in contact with the anode. As illustrated in FIGS. 2, 3, and 4, all surfaces of the anode may be in contact with the fuel, thus the area available for the reaction to occur is increased.

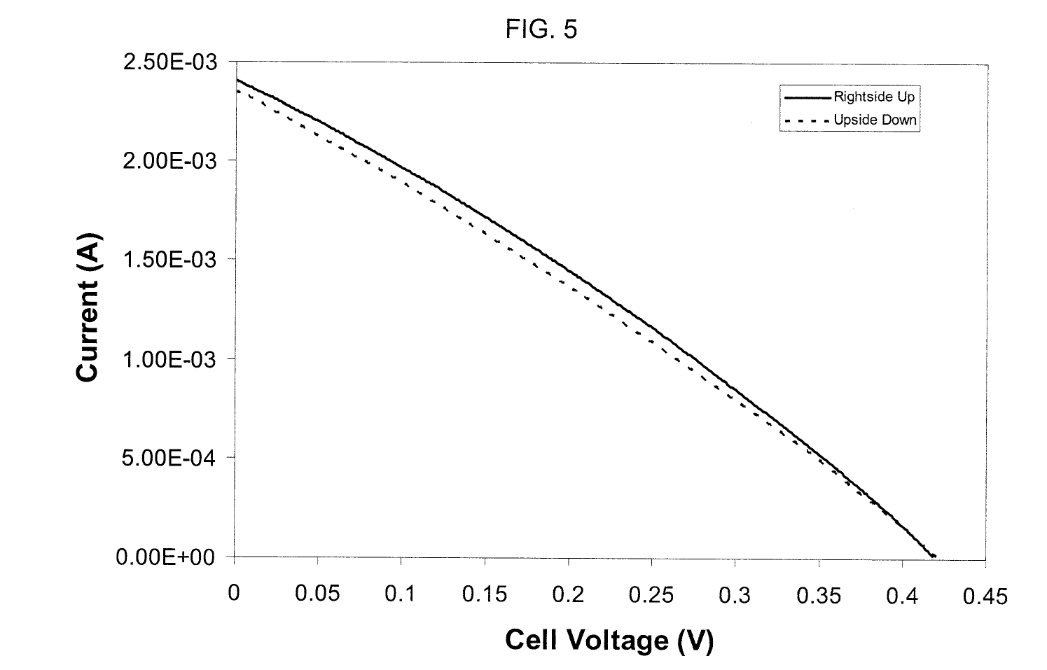

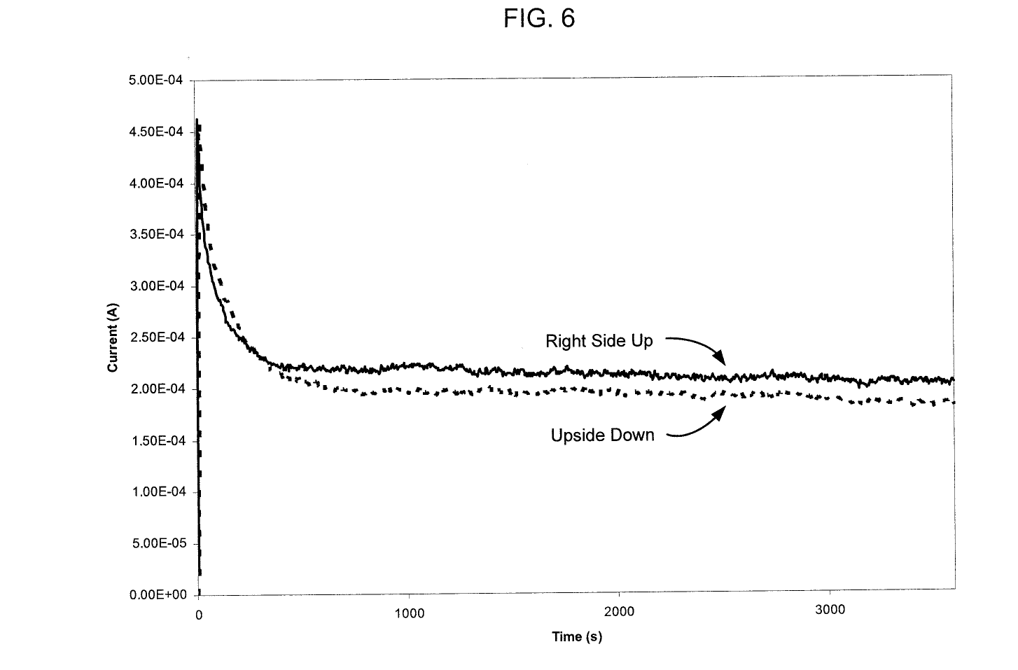

Third, by reducing the contact of the fuel with the PEM, methanol crossover is reduced. As discussed above, methanol crossover reduces the open circuit voltage of the cell and wastes fuel. Methanol crossover can be reduced by minimizing the contact area of the fuel and the PEM. As shown in FIGS. 2B and 4B, the fuel cell may operate in an orientation where the fuel is not in direct contact with the PEM. Further, as described below and illustrated in FIGS. 5 and 6, the performance of the cell is not significantly affected by the cell's orientation.

The results of a first experiment of a half cell incorporating a floating anode and an ion wick are shown in FIG. 5. The configuration of the fuel cell is shown in FIG. 2, although FIG. 2 is not drawn to scale. The “right-side up” data series corresponds to the orientation of the fuel cell shown in FIG. 2A, while the “up-side down” data series corresponds to the orientation of the fuel cell shown in FIG. 2B. In the experiment the fuel comprised 10 M methanol, and 0.1 M potassium sulfate. The PEM was comprised of Nafion (available from DuPont). In the experiment, the PEM of the fuel cell was 1 square centimeter. The experimental fuel cell contained 1 mL of fuel, and the wick was 2 centimeters in length. The experiment was conducted at a temperature of 23° C. and with a scan rate of 50 mV/s. As is illustrated in FIG. 5, the fuel cell's performance is minimally effected by the orientation of the fuel cell. The maximum divergence between the current in the “right-side up” and “up-side down” orientations is on the order of 100 μA.

The results of a second experiment are shown in FIG. 6. FIG. 6 shows the chronoamperometric results of a fuel cell comprising a floating anode and an ion wicking material. As in the first experiment, the “right-side up” data series corresponds to the orientation of the fuel cell shown in FIG. 2A, while the “up-side down” data series corresponds to the orientation of the fuel cell shown in FIG. 2B. The experiment was conducted at a temperature of 23° C. and with a cell operating voltage of 0.3 V. The experimental results further show that the fuel cell performs consistently and reliably in either orientation.

It should be emphasized that the described embodiments of this disclosure are merely possible examples of implementations and are set forth for a clear understanding of the principles of this disclosure. Many variations and modifications may be made to the described embodiments of this disclosure without departing substantially from the spirit and principles of this disclosure. All such modifications and variations are intended to be included herein within the scope of this disclosure and protected by the following claims.

1. A proton exchange membrane fuel cell comprising:
an ionically conductive liquid fuel solution;
an anode disposed in the liquid fuel solution;
a solid proton exchange membrane; and
a wicking material having a first end and a second end; the wicking material disposed such that the first end is immersed in the liquid fuel, and the second end is in contact with the solid proton exchange membrane.

2. The proton exchange membrane fuel cell of claim 1 wherein the anode is separated from the solid proton exchange membrane.

3. The proton exchange membrane fuel cell of claim 1 wherein the ionically conductive liquid fuel solution conducts cations produced at the anode by oxidizing the fuel to the solid proton exchange membrane.

4. The proton exchange membrane fuel cell of claim 1 wherein the liquid fuel solution comprises methanol.

5. The proton exchange membrane fuel cell of claim 1 wherein the liquid fuel solution comprises 0.01-24.7 M methanol.

6. The proton exchange membrane fuel cell of claim 1 wherein the liquid fuel solution further comprises an earth metal salt.

7. The proton exchange membrane fuel cell of claim 6 wherein the earth metal salt is selected from the group consisting of potassium sulfate and sodium bisulfate.

8. The proton exchange membrane fuel cell of claim 6 wherein a ratio of the earth metal salt to the liquid fuel solution is between 0.001 M per liter and 0.1 M per liter.

9. The proton exchange membrane fuel cell of claim 1 wherein the wicking material comprises cellulose foam.

10. The proton exchange membrane fuel cell of claim 1 wherein the wicking material comprises hydroxy-methyl-cellulose.

11. The proton exchange membrane fuel cell of claim 1 wherein the wicking material comprises hydrogel woven fibers.

12. The proton exchange membrane fuel cell of claim 1 wherein the wicking material comprises a lattice structure.

13. The proton exchange membrane fuel cell of claim 1 wherein the anode floats within the liquid fuel solution.

14. A method for utilizing a proton exchange membrane fuel cell, the method comprising:
providing an ionically conductive liquid fuel solution;
providing a solid proton exchange membrane;
placing an anode in contact with the liquid fuel solution;
placing a wicking material having a first and second end such that the first end is immersed in the liquid fuel solution and the second end is in contact with the solid proton exchange membrane.

15. The method of claim 14 wherein the anode is separated from the solid proton exchange membrane.

16. The method of claim 14 wherein the ionically conductive liquid fuel solution conducts cations produced at the anode by oxidizing the fuel to the solid proton exchange membrane.

17. The method of claim 14 wherein the anode floats within the liquid fuel solution.

18. The method of claim 14 wherein the liquid fuel solution comprises methanol.

19. The method of claim 14 wherein the liquid fuel comprises 0.01-24.7 M methanol.

20. The method of claim 14 wherein the liquid fuel further comprises an earth metal salt.

21. The method of claim 20 wherein the earth metal salt is selected from the group consisting of potassium sulfate and sodium bisulfate.

22. The method of claim 20 wherein a ratio of the earth metal salt to the liquid fuel solution is between 0.001 M per liter and 0.1 M per liter.

23. The method of claim 14 wherein the wicking material comprises cellulose foam.

24. The method of claim 14 wherein the wicking material comprises hydroxy-methyl-cellulose.

25. The method of claim 14 wherein the wicking material comprises hydrogel woven fibers.

26. The method of claim 14 wherein the wicking material comprises a lattice structure.

27. A proton exchange membrane fuel cell comprising:
an ionically conductive liquid fuel solution;
a solid proton exchange membrane;
an anode configured as a fuel reservoir for containing the liquid fuel; and
a wicking material having a first and a second end and disposed such that the first end is immersed in the liquid fuel solution, and the second end is in contact with the solid proton exchange membrane.

28. The proton exchange membrane fuel cell of claim 26 wherein the ionically conductive liquid fuel solution conducts cations produced at the anode by oxidizing the fuel to the solid proton exchange membrane.

29. The proton exchange membrane fuel cell of claim 26 wherein the liquid fuel solution comprises methanol.

30. The proton exchange membrane fuel cell of claim 26 wherein the liquid fuel comprises 0.01-24.7 M methanol.

31. The proton exchange membrane fuel cell of claim 26 wherein the liquid fuel further comprises an earth metal salt.

32. The proton exchange membrane fuel cell of claim 31 wherein the earth metal salt is selected from the group consisting of potassium sulfate and sodium bisulfate.

33. The proton exchange membrane fuel cell of claim 31 wherein a ratio of the earth metal salt to the liquid fuel solution is between 0.001 M per liter and 0.1 M per liter.

34. The proton exchange membrane fuel cell of claim 26 wherein the wicking material comprises cellulose foam.

35. The proton exchange membrane fuel cell of claim 26 wherein the wicking material comprises hydroxy-methyl-cellulose.

36. The proton exchange membrane fuel cell of claim 26 wherein the wicking material comprises hydrogel woven fibers.

37. The proton exchange membrane fuel cell of claim 26 wherein the fuel reservoir is approximately spherical.

38. The proton exchange membrane fuel cell of claim 26 wherein the wicking material comprises a lattice structure.

39. A proton exchange membrane fuel cell comprising:
an ionically conductive liquid fuel solution;
a solid proton exchange membrane;
an anode configured to remain in contact with the liquid fuel solution regardless of the orientation of the fuel cell; and
a wicking material disposed within the fuel cell such that a part of the wick is in contact with the liquid fuel solution in any orientation of the fuel cell and such that a part of the wicking material is in contact with the solid proton exchange membrane in any orientation of the fuel cell.

40. The proton exchange membrane fuel cell of claim 38 wherein the liquid fuel solution comprises methanol.

41. The proton exchange membrane fuel cell of claim 38 wherein the liquid fuel comprises 0.01-24.7 M methanol.

42. The proton exchange membrane fuel cell of claim 38 wherein the liquid fuel further comprises an earth metal salt.

43. The proton exchange membrane fuel cell of claim 42 wherein the earth metal salt is selected from the group consisting of potassium sulfate and sodium bisulfate.

44. The proton exchange membrane fuel cell of claim 42 wherein a ratio of the earth metal salt to the liquid fuel solution is between 0.001 M per liter and 0.1 M per liter.

45. The proton exchange membrane fuel cell of claim 38 wherein the wicking material comprises cellulose foam.

46. The proton exchange membrane fuel cell of claim 38 wherein the wicking material comprises hydroxy-methyl-cellulose.

47. The proton exchange membrane fuel cell of claim 38 wherein the wicking material comprises hydrogel woven fibers.

48. The proton exchange membrane fuel cell of claim 38 wherein the wicking material comprises a lattice structure.

49. The proton exchange membrane fuel cell of claim 38 wherein the anode floats within the liquid fuel solution.
